(19) United States
(12) Patent Application Publication
(10) Pub. No.: US 2025/0076607 A1
(43) Pub. Date: Mar. 6, 2025

(54) CAMERA STRUCTURE

(71) Applicant: Lanto Electronic Limited, Kunshan City (CN)

(72) Inventors: Ngoc-Luong NGUYEN, Kunshan City (CN); Wei-Han HSIA, Taipei City (TW); Po-Ying TSENG, Taipei City (TW); Wen-Yen HUANG, Taipei City (TW); Shang-Yu HSU, Taipei City (TW); Fu-Yuan WU, Taipei City (TW)

(73) Assignee: Lanto Electronic Limited, Kunshan City (CN)

(21) Appl. No.: 18/676,756

(22) Filed: May 29, 2024

(30) Foreign Application Priority Data
Sep. 4, 2023 (CN) 202311129501.5

(51) Int. Cl. G02B 7/02

(52) U.S. Cl. CPC G02B 7/023

(57) ABSTRACT

A camera structure, including a lens holder, a lens frame and a plurality of balls. The lens holder has a holder body, one end of which has a first rolling groove. The first groove wall part and the second groove wall part are disposed on two sides of the first rolling groove, and the groove bottom is disposed between the first groove wall part and the second groove wall part. The lens frame is mounted on an outer side of the holder body. The plurality of balls are located inside the first rolling groove, wherein the first groove wall part and the second groove wall part support the plurality of balls, there is a gap between each of the plurality of balls and the groove bottom, and the plurality of balls lay between the lens holder and the lens frame.

### CROSS REFERENCE TO RELATED APPLICATION

This application claims the priority benefit of Chinese Patent Application Serial Number 202311129501.5, filed on Sep. 4, 2023, the full disclosure of which is incorporated herein by reference.

### BACKGROUND

### Technical Field

The present application relates to a technical field of image capturing, and particularly relates to a specific camera structure.

### Related Art

In recent years, cameras have been continuously miniaturized and applied to electronic devices such as smartphones. In particular, there is a trend to use a spherical voice coil motor (VCM) in the camera to achieve high magnification, while the electronic device remain thin. In the spherical voice coil motor, contact between a ball and a groove is typically point or surface contact. Additionally, the groove is made of soft materials such as Liquid Crystal Polymer (LCP), plastic, etc. Therefore, when the electronic device is subjected to impact or any external force, stress concentration of point contact or surface contact is very high, thereby leading to the groove with surface recessions. When there are dents on the surface of the groove, motion control of charge carriers becomes difficult, and larger currents are required. Even though the currents are larger, the balls in the grooves may encounter collisions or vibrations, thereby leading to uneven movement of the charge carriers.

### SUMMARY

The embodiments of the present application provide a camera structure that collaborates balls and groove structures to address the issue of the excessive pressure caused by the point contact or the surface contact of the conventional balls.

In order to solve the aforementioned technical problem, the present application is implemented as follows:

A camera structure including a lens holder, a lens frame and a plurality of balls is provided. The lens holder has a holder body, wherein one side of the holder body has a first rolling groove, and the first rolling groove includes a first groove wall part, a second groove wall part and a groove bottom. The first groove wall part and the second groove wall part are disposed on two sides of the first rolling groove, and the groove bottom is disposed between the first groove wall part and the second groove wall part. The lens frame is mounted on an outer side of the holder body. A plurality of balls located inside the first rolling groove. The first groove wall part and the second groove wall part support the plurality of balls, there is a gap between each of the plurality of balls and the groove bottom, and the plurality of balls lay between the lens holder and the lens frame.

In one embodiment, an inner side of the lens frame has a second rolling groove relative to the holder body, the second rolling groove is relative to the first rolling groove, and the plurality of balls are located in the first rolling groove and the second rolling groove.

In one embodiment, a structure of the first rolling groove is same as a structure of the second rolling groove.

In one embodiment, the first groove wall part and the second groove wall part support surfaces of the plurality of balls through point support.

In one embodiment, the first groove wall part and the second groove wall part are arc surfaces which face each other, and the groove bottom has a sharp trough with two sides, and a side edge of the first groove wall part and a side edge of the second groove wall part are connected to the two sides of the sharp trough.

In one embodiment, an interior of the first groove wall part has a first blind groove corresponding to one side of the first rolling groove, and an interior of the second groove wall part has a second blind groove corresponding to the other side of the first rolling groove.

In one embodiment, the first groove wall part further includes a first through hole, one end of the first through hole is connected to the first rolling groove, and the other end of the first through hole is connected to the first blind groove; the second groove wall part further includes a second through hole, one end of the second through hole is connected to the first rolling groove and the other end of the second through hole is connected to the second blind groove.

In one embodiment, the groove bottom has a recessed groove with two sides, a side edge of the first groove wall part and a side edge of the second groove wall part are connected to the sides of an opening of the recessed groove.

In one embodiment, the groove bottom has a third blind groove located on one side of the recessed groove.

In one embodiment, the first groove wall part has a first protrusion, and the first protrusion fixes the surface of the ball; the second groove wall part has a second protrusion, and the second protrusion fixes the surface of the ball.

In one embodiment, a housing is further included, and the lens holder, the lens frame and the plurality of balls are disposed in the housing.

In one embodiment, the camera structure further includes a magnetic module, a motor coil and an electrical module, the holder body further includes an accommodating groove disposed on one side of the first rolling groove, the magnetic module is disposed in the accommodating groove, the electrical module is disposed on an inner wall of the housing, the motor coil is disposed on the electrical module, and the motor coil corresponds to the magnetic module.

The present application provides a camera structure. When the electronic device with the camera structure provided by the present application undergoes abnormal impact caused by external forces or falls down, the electronic device with the camera structure provided by the present application utilizes the gap between the ball and groove bottom to be the buffering space for support. When the ball compresses the first groove wall part and the second groove wall part to expand outward, the ball undergoes the buffer interaction of the gap so that the ball would buffer and undergo the support of the groove bottom. Thus, the external force on the balls will not directly impact the lens holder and internal components of the lens holder.

It should be understood, however, that this summary may not contain all aspects and embodiments of the present invention, that this summary is not meant to be limiting or restrictive in any manner, and that the invention as disclosed herein will be understood by one of ordinary skill in the art to encompass obvious improvements and modifications thereto.

### BRIEF DESCRIPTION OF THE DRAWINGS

The accompanying drawings herein are provided to have a further understanding on the present application and constitutes a part of the present application. The schematic embodiments and the description of the present application is used to explain the present application instead of constituting inappropriate limitation. In the drawings:

FIG. 1 is an exploded view of the camera structure in the present application;

FIG. 2 is a three-dimensional view of the internal components of the camera structure in the present application;

FIG. 3 is an exploded view of the internal components of the camera structure in the present application;

FIG. 4 is another exploded view of the internal components of the camera structure in the present application;

FIG. 5 is a sectional view along line A-A′ of FIG. 2;

FIG. 6 is an enlarged view of the first embodiment in region B of FIG. 5;

FIG. 7 is an enlarged view of the first embodiment in region D of FIG. 6;

FIG. 8 is an enlarged view of the second embodiment in region D of FIG. 6;

FIG. 9 is an enlarged view of the third embodiment in region C of FIG. 5;

FIG. 10 is an enlarged view of the fourth embodiment of the ball and groove in the present application;

FIG. 11 is an enlarged view of the fifth embodiment of the ball and groove in the present application;

FIG. 12 is an enlarged view of the sixth embodiment of the ball and groove in the present application;

FIG. 13 is an enlarged view of the seventh embodiment of the ball and groove in the present application.

Considering the accompanying diagrams, the explanations are as follows:

1: camera structure; 11: lens holder; 111: holder body; 112: first rolling groove; 1121: first groove wall part; 11211: first protrusion; 11212: first blind groove; 11213: first through hole; 1122: second groove wall part; 11222: second blind groove; 11223: second through hole; 1123: groove bottom; 1123A: sharp trough; 1123B: flat bottom; 1123C: recessed groove; 1123D: recessed groove; 11231: third blind groove; 113: lens; 114: accommodating groove; 12: lens frame; 121: frame body; 122: opening; 123: perforation; 124: second rolling groove; 1241: first groove wall; 1242: second groove wall; 1243: groove bottom; 13: ball; 14: magnetic module; 15: motor coil; 16: electrical module; 17: housing; 171: upper shell; 1711: lens hole; 172: lower shell; G: gap.

### DETAILED DESCRIPTION OF THE EMBODIMENTS

The multiple embodiments of the present application are disclosed by the drawings as follows, and for precise explanation, the implementing details of the present application will be described together with the multiple embodiments of the present application in the following paragraphs. However, it should be understood that the implementing details of the present application should not be construed as the restrictions of the present application. In other words, in some of the embodiments of the present application, the implement details of the present application are not essential. Besides, for simplifying the drawings, some well-known structures and modules are schematically shown to simplify the drawings. In the following embodiments, the same reference numerals in different drawings represent the same or similar modules.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the invention. This description is made for the purpose of illustration of the general principles of the invention and should not be taken in a limiting sense. The scope of the invention is best determined by reference to the appended claims.

Moreover, the terms “include”, “contain”, and any variation thereof are intended to cover a non-exclusive inclusion. Therefore, a process, method, object, or device that comprises a series of elements not only include these elements, but also comprises other elements not specified expressly, or may include inherent elements of the process, method, object, or device. If no more limitations are made, an element limited by “include a/an . . . ” does not exclude other same elements existing in the process, the method, the article, or the device which comprises the element.

In the following embodiment, the same reference numerals are used to refer to the same or similar elements throughout the invention.

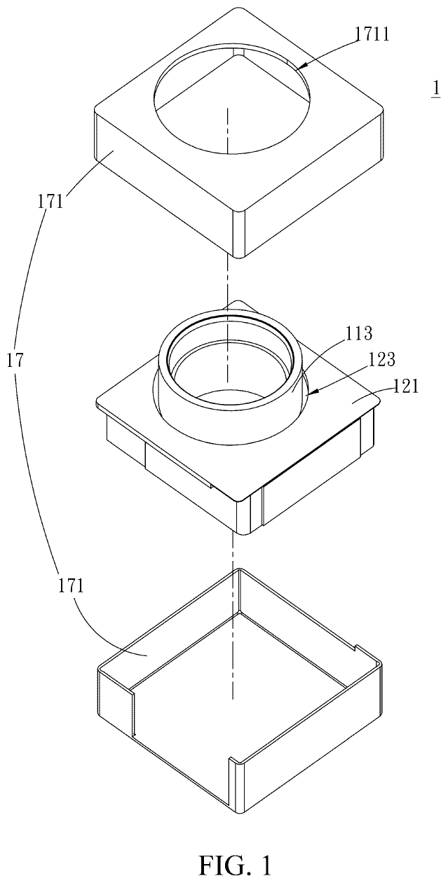

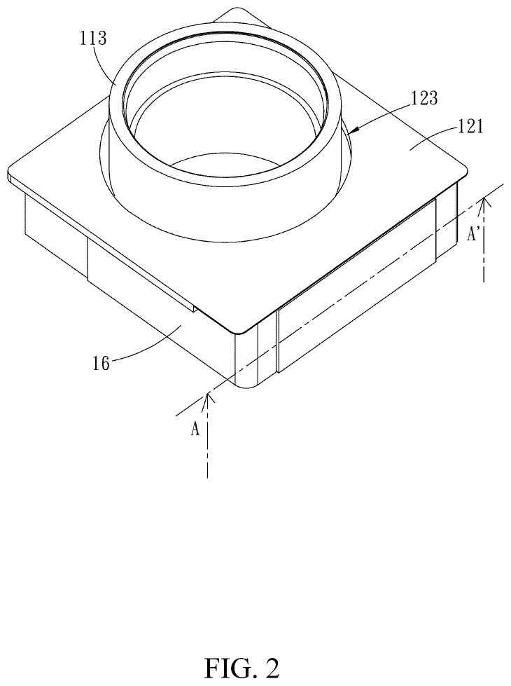

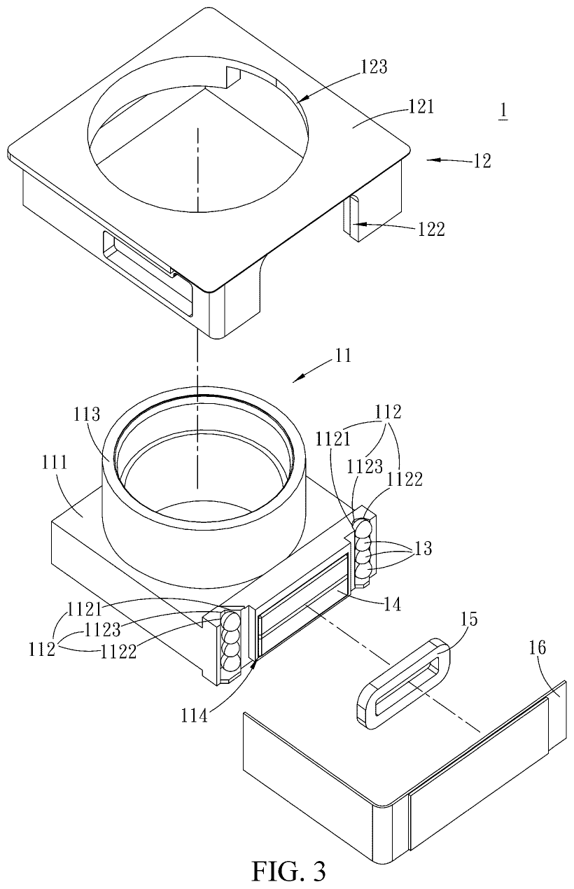

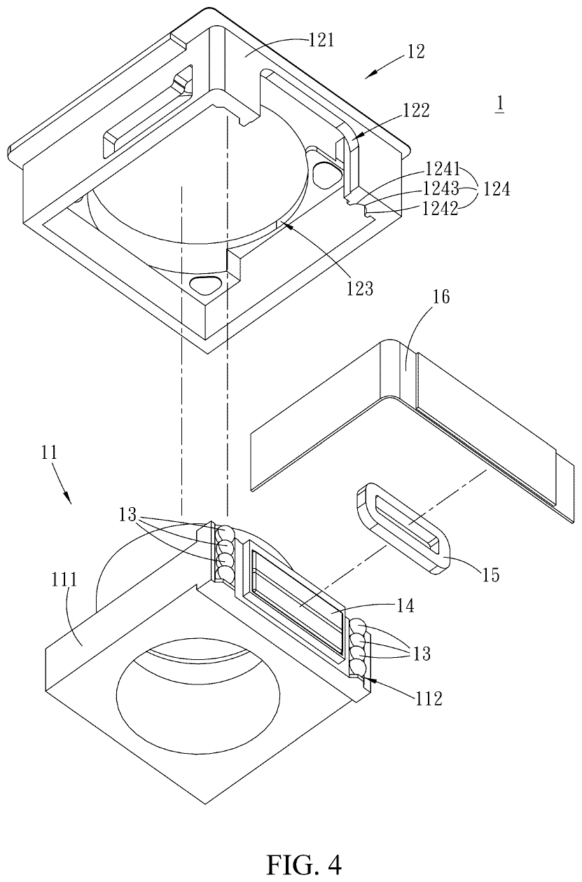

Please refer to FIG. 1 to FIG. 4. FIG. 1 is an exploded view of the camera structure in the present application, FIG. 2 is a three-dimensional view of the internal components of the camera structure, FIG. 3 is an exploded view of the internal components of the camera structure, and FIG. 4 is another exploded view of the internal components of the camera structure. As shown in the figures, the present application provides a camera structure 1, which includes a lens holder 11, a lens frame 12 and a plurality of balls 13. The lens holder 11 has a holder body 111, and one side of the holder body 111 has a first rolling groove 112. The first rolling groove 112 includes a first groove wall part 1121, a second groove wall part 1122 and a groove bottom 1123. The first groove wall part 1121 and the second groove wall part 1122 are disposed on the two sides of the first rolling groove 112, and the groove bottom 1123 is disposed between the first groove wall part 1121 and the second groove wall part 1122. The lens frame 12 is mounted on the outside of the holder body 111. The plurality of balls 13 are located inside the first rolling groove 112, and the first groove wall part 1121 and the second groove wall part 1122 support the plurality of balls 13. There is a gap G between each of the plurality of balls and the groove bottom 1223, and the plurality of balls 13 lay between the lens holder 11 and the lens frame 12. The first groove wall part 1121 and the second groove wall part 1122 of the first rolling groove 112 support the surface of each of the plurality of balls 13 through point support, and the structure of the first groove wall part 1121 and the structure of the second groove wall part 1122 are symmetrical to each other. In addition, the different structures of the two first rolling grooves 112 on the lens holder 11 in FIG. 3 and FIG. 4 of the present application merely serve as references. The two identical first rolling grooves 112 may be manufactured according to user requirements.

In this embodiment, the camera structure 1 further includes a magnetic module 14, a motor coil 15, and an electrical module 16. The lens holder 11 also includes a lens 113 and an accommodating groove 114. The lens 113 is located above the holder body 111. The accommodating groove 114 is located on the side face of the holder body 111, and the accommodating groove 114 is disposed on one side of the first rolling groove 112, and the magnetic module 14 is disposed inside the accommodating groove 114. The lens frame 12 has a frame body 121, and the frame body 121 has an opening 122 relative to the position of the accommodating groove 114. In other words, the opening 122 corresponds to the position of the magnetic module 14. The motor coil 15 is correspondingly disposed on one side of the magnetic module 14, and the motor coil 15 is located within the opening 122 of the lens frame 12. The inner side of the electrical module 16 is electrically connected to the side of the motor coil 15 far away from the magnetic module 14. The electrical module 16 has an L-shaped structure and is disposed by extending along the outer side wall of the lens frame 12. In addition, the frame body 121 of the lens frame 12 has a through hole 123 relative to the position of the lens 113, the lens frame 12 is mounted on the lens holder 11, and the lens 113 passes through the through hole 123.

As mentioned above, the camera structure 1 further includes a housing 17 with an upper shell 171 and a lower shell 172. The lens holder 11, the lens frame 12, the plurality of balls 13, the magnetic module 14, the motor coil 15 and the electrical module 16 are all arranged within the lower shell 172 of the housing 17. The outer side of the electrical module 16 is disposed on the inner wall of the lower shell 172. Moreover, the upper shell 171 of the housing 17 has a lens hole 1711, the upper shell 171 covers the upper side of the lens holder 11 and the lens frame 12, and the lens 113 of the lens holder 11 passes through the lens hole 1711.

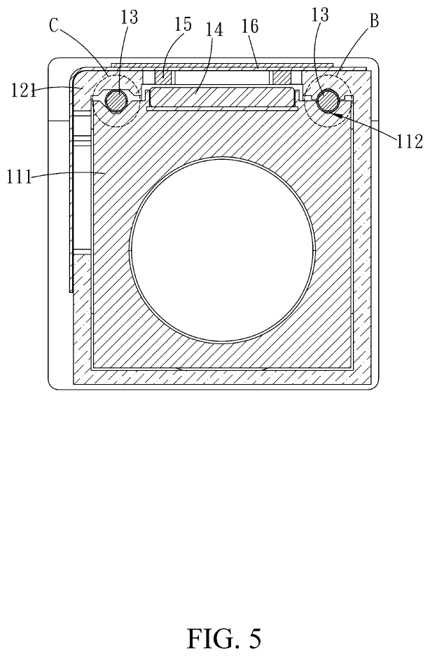

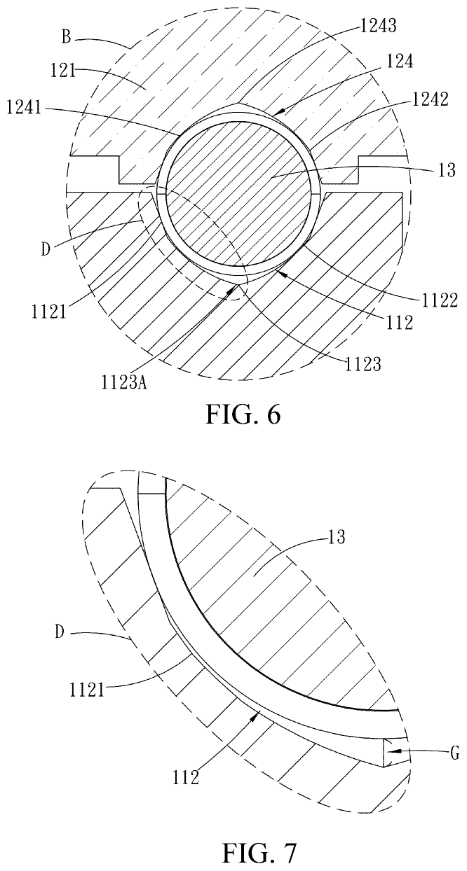

Please also refer to FIG. 5 to FIG. 7. FIG. 5 is a sectional view along line A-A′ of FIG. 2, FIG. 6 is an enlarged view of the first embodiment in region B of FIG. 5, and FIG. 7 is an enlarged view of the first embodiment in region D of FIG. 6. As shown in these figures, in this embodiment, the first groove wall part 1121 and the second groove wall part 1122 are arc surfaces which face each other, and the groove bottom 1123 has a sharp trough 1123A, and the side edges of the first groove wall part 1121 and the second groove wall part 1122 connect to both sides of the sharp trough 1123A of the groove bottom 1123. Additionally, in this embodiment, the side edges of the first groove wall part 1121 and the second groove wall part 1122 can be directly connected to each other to form the structure of the sharp trough 1123A. The balls 13 are disposed inside the first rolling groove 112, and the arc surfaces of the first groove wall part 1121 and the second groove wall part 1122 of the first rolling groove 112 which face each other support the surface of each ball 13 through the point support. In other words, the surface of each ball 13 has point-to-point support relative to the first groove wall part 1121 and the second groove wall part 1122.

As mentioned above, when the holder body 111 of the lens holder 11 moves relative to the lens frame 12, the motor coil 15 is conducted through the electrical module 16, and the electrical module 16 changes the magnetic field of the motor coil 15. Under the interaction of the magnetic fields between the motor coil 15 and the magnetic module 14, the holder body 111 of the lens holder 11 is driven to move relative to the lens frame 12. The balls 13 roll between the first rolling groove 112 of the holder body 111 and the inner wall of the lens frame 12 to assist in the displacement of the lens holder 11 relative to the lens frame 12. During the aforementioned movement process, the lens frame 12 collides and compresses against the lens holder 11, and the lens frame 12 first compresses against the balls 13, and then the balls 13 compresses against the first groove wall part 1121 and the second groove wall part 1122 of the first rolling groove 112. When the balls compress the first groove wall part 1121 and the second groove wall part 1122 to expand outward, the balls 13 first move downward by a distance of a gap G (i.e., the distance between the ball 13 and the groove bottom 1123) as the buffer so that the balls 13 would slowly contact the groove bottom 1123 and be supported by the sharp trough 1123A of the groove bottom 1123 after the external force of the balls 13 is cancelled by the reaction force of the first groove wall part 1121 and the second groove wall part 1122 which expand outward. Thus, the external force of the balls 13 does not directly act on the lens holder 11 and the internal components of the lens holder 11, and most of the external force of the balls 13 is cancelled, and the impact of the external force of the balls 13 on the lens holder 11 and the internal components of the lens holder 11 is less.

Furthermore, in the first embodiment, the inner side of the frame body 121 of the lens frame 12 has a second rolling groove 124 relative to the holder body 111. The second rolling groove 124 is relative to the first rolling groove 112, and the plurality of balls 13 are located in both the first rolling groove 112 and the second rolling groove 124 so that the balls 13 roll within both the first rolling groove 112 and the second rolling groove 124. The structure of the second rolling groove 124 is identical to that of the first rolling groove 112. In other words, the second rolling groove 124 has the first groove wall part 1241 and the second groove wall part 1242. The first groove wall part 1121 and the second groove wall part 1122 are arc surfaces which face each other and support the surface of each ball 13 by the point support, and the second rolling groove 124 has the same structural effects as the first rolling groove 112, and thus, the elaboration of the second rolling groove 124 is omitted. The second rolling groove 124 serves as the structure to assist the balls 13 in rolling between the lens holder 11 and the lens frame 12. Additionally, the structure of the first rolling groove 112 and the structure of the second rolling groove 124 can be adjusted according to user requirements so that the structures of the first rolling groove 112 and the second rolling groove 124 are identical or different.

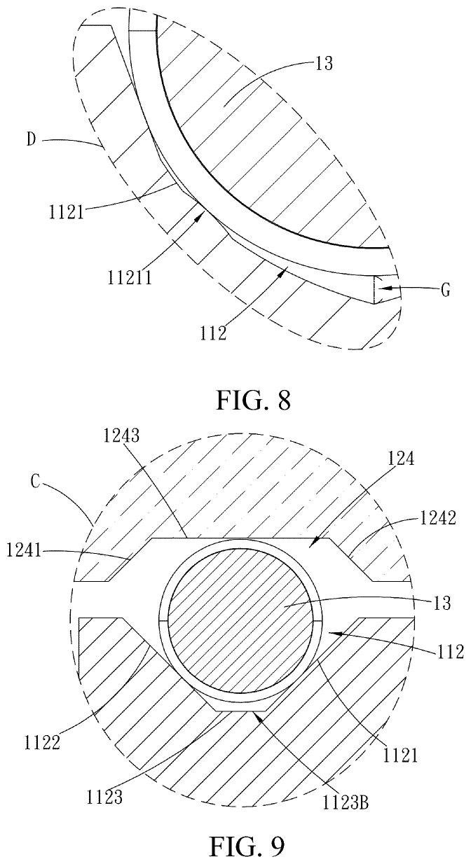

Please refer to FIG. 8, which is an enlarged view of the second embodiment in region D of FIG. 6. As shown in the FIG. 8, the difference between the second embodiment and the first embodiment lies in the first groove wall part 1121 and the second groove wall part 1122. The first groove wall part 1121 has a first protrusion 11211, the first protrusion 11211 is fixed to the surface of ball 13; the second groove wall part 1122 relative to the first groove wall part 1121 has a corresponding second protrusion (not shown), and the second protrusion is fixed to the other surface of ball 13. Thus, the second embodiment can enhance the external force of the first groove wall part 1121 and the second groove wall part 1122 on the point support of the ball 13, and the external force of the first groove wall part 1121 and the second groove wall part 1122 on the point support of the ball 13 can be the structure assisting the external force of the ball 13 in acting on the first groove wall part 1121 and the second groove wall part 1122.

Please refer to FIG. 9, which is an enlarged view of the third embodiment in region C of FIG. 5. As shown in the FIG. 9, the difference between the third embodiment and the first embodiment lies in the structure of the first rolling groove 112 and the structure of the second rolling groove 124. The first groove wall part 1121 and the second groove wall part 1122 are inclined planes which face each other, and the groove bottom 1123 is a flat bottom 1123B, and the side edge of the first groove wall part 1121 and the side edge of the second groove wall part 1122 are connected to the two sides of the groove bottom 1123. The ball 13 is disposed between the first rolling groove 112 and the second rolling groove 124, and the inclined planes of first groove wall part 1121 and second groove wall part 1122 of the first rolling groove 112 which face other support surface of the ball 13 by the point support. Additionally, the structure of the second rolling groove 124 is different from that of the first rolling groove 112, the first groove wall part 1121 and the second groove wall part 1122 of the second rolling groove 124 are the inclined planes which face each other, the groove bottom 1243 of the second rolling groove 124 is a plane, the groove bottom 1243 of the second rolling groove 124 abut against the surface of the ball 13, and the first groove wall part 1121 and the second groove wall part 1122 do not touch the surface of the ball 13.

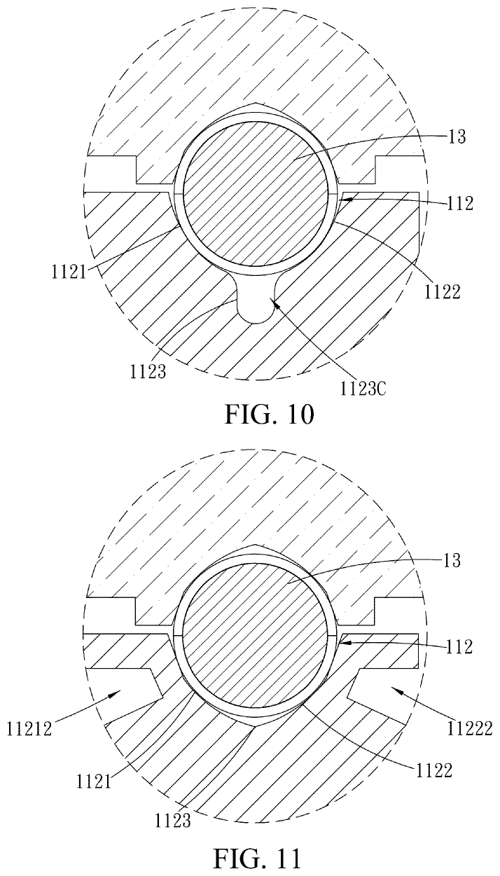

Please refer to FIG. 10, which is an enlarged view of the fourth embodiment of the ball and the groove in the present application. As shown in the FIG. 10, the difference between the fourth embodiment and the first embodiment lies in the structure of the groove bottom 1123 of the first rolling groove 112. In the fourth embodiment, the groove bottom 1123 has a recessed groove 1123C, which is an arc bottom. The side edge of the first groove wall part 1121 and the side edge of the second groove wall part 1122 are connected to the side edges of the opening of the recessed groove 1123C of the groove bottom 1123. The ball 13 is disposed between the first rolling groove 112 and the second rolling groove 124, and the point support manner of the first groove wall part 1121 and the second groove wall part 1122 of the first rolling groove 112 support the surface of the ball 13. When the ball 13 compresses the first groove wall part 1121 and the second groove wall part 1122 to expand outward, because the structure strength of the first groove wall part 1121 and the second groove wall part 1122 can be declined by the recessed groove 1123C of the groove bottom 1123, the recessed groove 1123C of the groove bottom 1123 can assist the first groove wall part 1121 and the second groove wall part 1122 to expand outward and deform to achieve the effect of cancelling and buffering the external force of the ball 13, and the details are not further elaborated.

Please refer to FIG. 11, which is an enlarged view of the fifth embodiment of the ball and groove in the present application. As shown in the FIG. 11, the difference between the fifth embodiment and the first embodiment lies in the structure of the first groove wall part 1121 and the structure of the second groove wall part 1122 of the first rolling groove 112. In the fifth embodiment, the interior of the first groove wall part 1121 has a first blind groove 11212 corresponding to one side of the first rolling groove 112 and the ball 13, and the interior of the second groove wall part 1122 has a second blind groove 11222 corresponding to the other side of the first rolling groove 112 and the ball 13. When the ball 13 compresses the first groove wall part 1121 and the second groove wall part 1122 to expand outward, because the structure strength of the first groove wall part 1121 can be declined by the first blind groove 11212 and the structure strength of the second groove wall part 1122 can be declined by the second blind groove 11222, the first blind groove 11212 and the second blind groove 11222 can assist the first groove wall part 1121 and the second groove wall part 1122 to expand outward and deform to achieve the effect of cancelling and buffering the external force of the ball 13, and the details are not further elaborated.

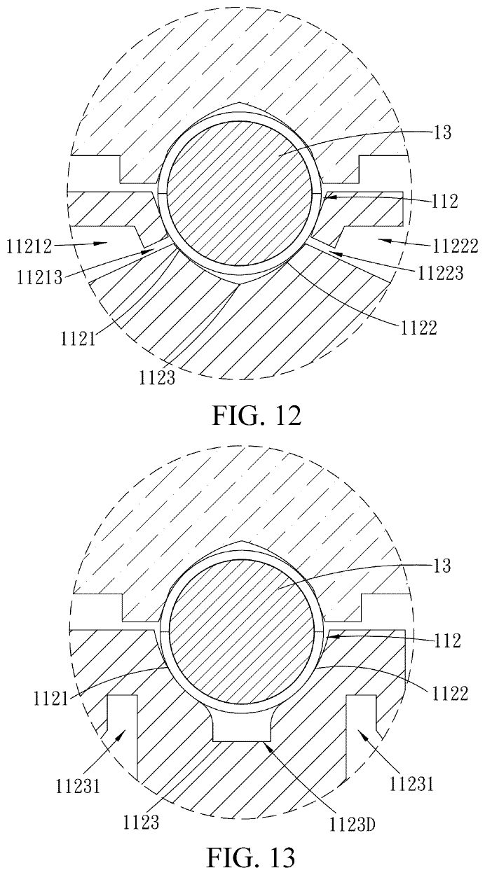

Please refer to FIG. 12, which is an enlarged view of the sixth embodiment of the ball and groove in the present application. As shown in the FIG. 12, the difference between the sixth embodiment and the fifth embodiment lies in the structure of the first groove wall part 1121 and the structure of the second groove wall part 1122 of the first rolling groove 112. In the sixth embodiment, the first groove wall part 1121 further has a first through hole 11213, and one end of the first through hole 11213 is connected to the first rolling groove 112, and the other end of the first through hole 11213 is connected to the first blind groove 11212. The second groove wall part 1122 further has a second through hole 11223, and one end of the second through hole 11223 is connected to the first rolling groove 112, and the other end of the second through hole 11223 is connected to the second blind groove 11222. When the balls 13 compress the first groove wall part 1121 and the second groove wall part 1122 to expand outward, because the structural strength of the first groove wall part 1121 is declined by the first blind groove 11212 and the first through hole 11213 and the structural strength of the second groove wall part 1122 can be declined by the second blind groove 11222 and the second through hole 11223, the first through hole 11213 and the second through hole 11223 can assist the first groove wall part 1121 and the second groove wall part 1122 to expand outward and deform to achieve the effect of cancelling and buffering the external force of the ball 13, and the details are not further elaborated.

Please refer to FIG. 13, which is an enlarged view of the seventh embodiment of the ball and groove in the present application. As shown in the FIG. 13, the difference between the seventh embodiment and the fourth embodiment lies in the groove bottom 1123. In the seventh embodiment, the groove bottom 1123 has a recessed groove 1123D whose bottom is flat. The interior of the groove bottom 1123 has a third blind groove 11231 located on one side of the recessed groove 1123D. In the seventh embodiment, there are two third blind groove 11231 located at two sides of the recessed groove 1123D respectively, and the third blind groove 11231 can be set according to the users' requirement. When the ball 13 compresses the first groove wall part 1121 and the second groove wall part 1122 to expand outward, because the structural strength of the first groove wall part 1121 and the structural strength of the second groove wall part 1122 can be declined by the third blind groove 11231, the third blind groove 11231 can assist the first groove wall part 1121 and the second groove wall part 1122 to expand outward and deform to achieve the effect of cancelling and buffering the external force of the balls 13, and the details are not further elaborated.

In summary, the present application provides a camera structure. When the electronic device with the camera structure provided by the present application undergoes abnormal impact caused by external forces or falls down, the electronic device with the camera structure provided by the present application utilizes the gap between the ball and groove bottom to be the buffering space for support. When the ball compresses the first groove wall part and the second groove wall part to expand outward, the ball undergoes the buffer interaction of the gap so that the ball would buffer and undergo the support of the groove bottom. Thus, the external force on the balls will not directly impact the lens holder and internal components of the lens holder.

When the ball compresses the first and second groove wall parts to expand outward, the balls are affected by the buffer gap, making the balls first receive the support of groove bottom and be buffered, so that the external force on the balls will not directly cause influence on the lens holder and the components inside.

It is to be understood that the term “comprises”, “comprising”, or any other variants thereof, is intended to encompass a non-exclusive inclusion, such that a process, method, article, or device of a series of elements not only include those elements but also comprises other elements that are not explicitly listed, or elements that are inherent to such a process, method, article, or device. An element defined by the phrase “comprising a . . . ” does not exclude the presence of the same element in the process, method, article, or device that comprises the element.

Although the present invention has been explained in relation to its preferred embodiment, it does not intend to limit the present invention. It will be apparent to those skilled in the art having regard to this present invention that other modifications of the exemplary embodiments beyond those embodiments specifically described here may be made without departing from the spirit of the invention. Accordingly, such modifications are considered within the scope of the invention as limited solely by the appended claims.

What is claimed is:

1. A camera structure, comprising:
a lens holder having a holder body, wherein one side of the holder body has a first rolling groove, and the first rolling groove includes a first groove wall part, a second groove wall part and a groove bottom, and the first groove wall part and the second groove wall part are disposed on two sides of the first rolling groove, and the groove bottom is disposed between the first groove wall part and the second groove wall part;
a lens frame mounted on an outer side of the holder body; and
a plurality of balls located inside the first rolling groove, wherein the first groove wall part and the second groove wall part support the plurality of balls, there is a gap between each of the plurality of balls and the groove bottom, and the plurality of balls lay between the lens holder and the lens frame.

2. The camera structure as claimed in claim 1, wherein an inner side of the lens frame has a second rolling groove relative to the holder body, the second rolling groove is relative to the first rolling groove, and the plurality of balls are located in the first rolling groove and the second rolling groove.

3. The camera structure as claimed in claim 2, wherein a structure of the first rolling groove is same as a structure of the second rolling groove.

4. The camera structure as claimed in claim 1, wherein the first groove wall part and the second groove wall part support surfaces of the plurality of balls through point support.

5. The camera structure as claimed in claim 1, wherein the first groove wall part and the second groove wall part are arc surfaces which face each other, and the groove bottom has a sharp trough with two sides, and a side edge of the first groove wall part and a side edge of the second groove wall part are connected to the two sides of the sharp trough.

6. The camera structure as claimed in claim 1, wherein an interior of the first groove wall part has a first blind groove corresponding to one side of the first rolling groove, and an interior of the second groove wall part has a second blind groove corresponding to the other side of the first rolling groove.

7. The camera structure as claimed in claim 6, wherein the first groove wall part further comprises a first through hole, one end of the first through hole is connected to the first rolling groove, and the other end of the first through hole is connected to the first blind groove; the second groove wall part further comprises a second through hole, one end of the second through hole is connected to the first rolling groove and the other end of the second through hole is connected to the second blind groove.

8. The camera structure as claimed in claim 1, wherein the groove bottom has a recessed groove with two sides, a side edge of the first groove wall part and a side edge of the second groove wall part are connected to the sides of an opening of the recessed groove.

9. The camera structure as claimed in claim 8, wherein the groove bottom has a third blind groove located on one side of the recessed groove.

10. The camera structure as claimed in claim 1, wherein the first groove wall part has a first protrusion, and the first protrusion fixes the surface of the ball; the second groove wall part has a second protrusion, and the second protrusion fixes the surface of the ball.

11. The camera structure as claimed in claim 1, further comprising a housing where the lens holder, the lens frame and the plurality of balls are disposed.

12. The camera structure as claimed in claim 11, wherein the camera structure further comprises a magnetic module, a motor coil and an electrical module, the holder body further comprises an accommodating groove disposed on one side of the first rolling groove, the magnetic module is disposed in the accommodating groove, the electrical module is disposed on an inner wall of the housing, the motor coil is disposed on the electrical module, and the motor coil corresponds to the magnetic module.
